(19) United States
(12) Patent Application Publication
(10) Pub. No.: US 2002/0149462 A1
(43) Pub. Date: Oct. 17, 2002

(54) Service switching device

(76) Inventors: Winrich Habedank, Leimen (DE); Walter Kahl, Walldorf (DE); Bernd Siedelhofer, Heidelberg (DE); Ralf Wieland, Waldbrunn (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/122,485

(22) Filed: Apr. 11, 2002

(30) Foreign Application Priority Data
Apr. 11, 2001 (DE) 101 18 098.5

(51) Int. Cl. H01H 37/52; H01H 37/00; H01H 71/16; H02H 5/04

(52) U.S. Cl. 337/13; 337/12; 337/37; 337/36; 337/38; 361/105

(57) ABSTRACT

A service switching device is described. The service switching device has a thermal release, an electromagnetic release, a switching mechanism with a latching point, a contact point with a moving contact piece and a stationary contact piece. When an over-current condition occurs, the thermal release unlatches the latching point so that the contact points are opened permanently and, when a short-circuit current occurs, the electromagnetic release moves the moving contact piece to the open position. The service switching device has a housing and an associated actuator in the form of a piezoelectric bending strip, which likewise acts on the latching point in order to open the contact point permanently, with a fault current detection device being provided, whose output signal drives the actuator when a fault current occurs.

### BACKGROUND OF THE INVENTION

Field of the Invention:

The invention relates to a service switching device having a thermal and electromagnetic release, a switching mechanism with a latching point, a contact point with a moving contact piece and a stationary contact piece. When an overcurrent occurs, the thermal release unlatches the latching point so that the contact points are opened permanently and, when a short-circuit current occurs, the electromagnetic release moves the moving contact piece to the open position.

A service device such as this is commercially available, and is known in the form of a circuit breaker.

A service switching device such as this frequently has an associated fault current protection device, with the fault current protection device either being associated in the form of a fault current circuit breaker with the circuit breaker itself, or being located as a fault current detection device within the housing of the circuit breaker, in which case the size of the housing must be matched to it.

In the case of fault current circuit breakers which, for example, contain a holding magnet release as the tripping device, a problem arises in that such holding magnet releases do not trip in a small number of cases.

In order to avoid this, a fault current circuit breaker has been proposed, see German Patent Applications DE 41 42 969 and DE 41 42 970, in which the release has an element composed of an electrostrictive material, which changes its shape when a voltage occurs. One such element is in this case a piezo-element, which acts on a latching point of a switching mechanism of the fault current circuit breaker. Neither of the two documents makes any statement relating to the configuration of the release.

Bending strips or elongatable elements are used as the piezo-element, with the former bending when a signal voltage occurs, and the latter elongating. Elements in the form of bending strips have become known in the case of switching devices according to International Patent Application WO 98/40917. The release elements are composed of two bending strips, which result in greater deflection at a free end. However, bending strips such as these are complex to manufacture.

U.S. Pat. No. 4,042,967 discloses a fault current circuit breaker in which the output signal from the core balance current transformer is supplied to a piezo bending strip, which closes a contact point in a conductor run between a mains conductor and ground, which causes a relay that is located in the conductor run to respond, and in this way opens a contact point in the mains conductors.

### SUMMARY OF THE INVENTION

It is accordingly an object of the invention to provide a service switching device which overcomes the above-mentioned disadvantages of the prior art devices of this general type, which has a simple configuration, and in which a commercially available piezo-element in the form of a bending strip can be used.

With the foregoing and other objects in view there is provided, in accordance with the invention, a service switching device. The service switching device contains a moving contact piece and a stationary contact piece. When an the latching point so that the contact point is opened permanently and, when a short-circuit current condition occurs, the electromagnetic release moves the moving contact piece to an open position. A housing is provided. An actuator in a form of a piezoelectric bending strip is disposed in the housing, and the actuator acts on the latching point in order to open the contact point permanently. A fault current detection device outputs an output signal for driving the actuator when a fault current occurs.

The configuration of the housing for the service switching device allows the actuator as well as the fault current detection device to be accommodated together with a circuit breaker configuration in one housing.

Normal housings for circuit breakers are T-shaped, with the one, free side of the transverse bar forming the base surface, and the switching toggle projecting out of the end face of the web. Normally, the transverse bar projects beyond the web approximately symmetrically on both sides, since retaining openings for connecting terminals are provided in the so-called rear front faces provided on the transverse bar. In the configuration of the housing according to the invention, the transverse bar is lengthened to such an extent that the fault current detection device and the actuator can be installed there.

The actuator may run approximately parallel to, or at right angles to, the mounting side; it may act directly on the latching point, or it may act on the slide in the case of a circuit breaker in which the thermal release acts on the latching point via a slide. In circuit breakers in which the armature acts on the slide via a double-armed lever, the actuator may act on the double-armed lever directly or via a coupling piece. In this case, the coupling piece may be in the form of an L-shaped lever or, it may be in the form of a slide element.

In one particularly advantageous refinement of the invention, the coupling piece may also be mounted on the actuator.

In accordance with an added feature of the invention, the housing has broad sides, a mounting side, and a widened region projecting in a direction of the broad sides and the mounting side, and the widened region holds the actuator together with the fault current detection device.

In accordance with a further feature of the invention, the actuator is inclined with respect to the mounting side at an angle which is not equal to 90 degrees. The actuator can act directly on the latching point.

In accordance with an additional feature of the invention, a slide runs substantially parallel to the mounting side, and the thermal release and the actuator act on the slide. An armature is provided that acts on a double-armed lever. The double-armed lever acts on the slide, and via the slide the latching point is unlatched.

In accordance with a further additional feature of the invention, the actuator acts on the latching point through the coupling piece.

In accordance with another added feature of the invention, the coupling piece is an L-shaped lever having an arm with an arm end mounted such that the L-shaped lever can rotate and, in a region of a rotation axis, the L-shaped lever has a tab on which the actuator acts.

In accordance with a concomitant feature of the invention, the coupling piece acts on the double-armed lever.

Other features which are considered as characteristic for the invention are set forth in the appended claims.

Although the invention is illustrated and described herein as embodied in a service switching device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, elevational view of a fault current circuit breaker with a fault current detection device being indicated by dashed and dotted lines and according to the invention; and

FIGS. 2 to 6 are diagrammatic, elevational views of further embodiment of the fault current circuit breaker.

### DESCRIPTION OF THE PREFERRED EMBODIMENTS

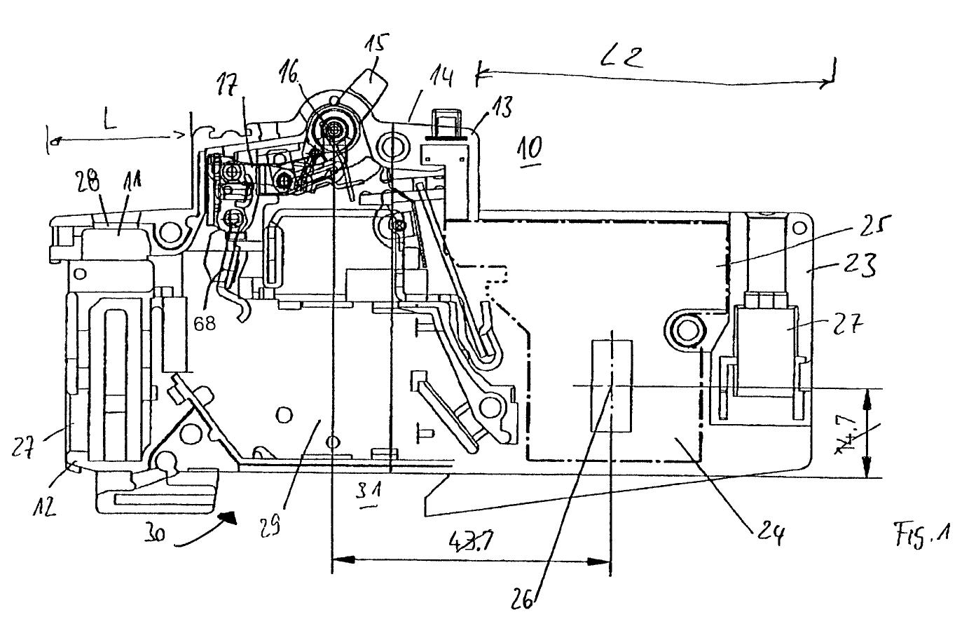

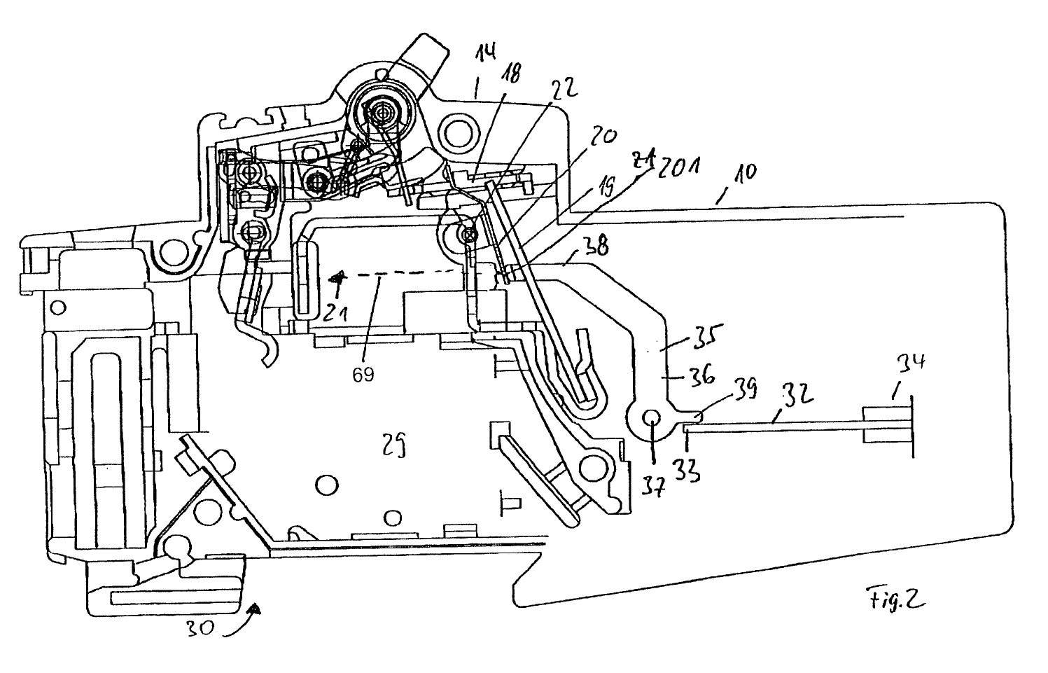

Referring now to the figures of the drawing in detail and first, particularly, to FIG. 1 thereof, there is shown a view of a service switching device 10. The service switching device has a housing 11 that is T-shaped with a transverse bar 12 and a web 13 running at right angles to the transverse bar 12. A switching toggle 15 projects from an end face 14 of the web 13, and is mounted on a shaft 16 such that it can rotate, and can be used to operate a switching mechanism 17, in order to move a contact lever 68 from a connected position to a disconnected position, and back. The switching mechanism 17 has a latching point, which is not shown in more detail, on which a slide 18, which is illustrated in FIG. 2, can act; a bimetallic strip 19 acts on the slide 18. There is also a non-illustrated electromagnet system which responds to short circuits, with an armature 69 being provided which is represented by dashed lines and interacts with a double-armed lever 20, with the armature 39 pivoting the double-armed lever 20 counterclockwise as shown by the direction of an arrow 21. The other arm of the double-armed lever 20 acts on the slide 18, and hence on the latching point in the switching mechanism 17. During tripping, the armature 39 at the same time also acts on the moving contact lever 18, and forces it to its opened position. The double-armed lever 20 is mounted on a rotating shaft 22 such that it can rotate. To this extent a conventional circuit breaker has been discussed.

It can be seen from FIG. 1 that the transverse bar 12 projects to the left from the web 13 only through a length L beyond the web 13, while, in contrast, by a length L2 of a region 23 located on the right in the drawing which is more than twice as long. This creates a space 24 within the housing in the transverse bar 12 in the region 23 located on the right in the drawing, into which a printed circuit board 25 can be inserted, on which switching elements as well as a core balance current transformer 26 (which are not shown in any more detail) can be fitted. A length of a subregion 27 of the transverse bar 12 is chosen such that a connecting terminal (which is not shown in any more detail) can also be installed, with the connecting terminal being accessible through an access opening 28, using a tool.

To complete the service switching device, the housing 11 has an accommodation area 29 for a non-illustrated arcing chamber with arcing plates. A recess 31 is provided on a mounting plane, side or face 30 located opposite the end surfaces 14, by which the service device can be snapped onto a top-hat profile mounting rail, which is likewise not illustrated.

When a fault current occurs, a piezo-element is driven via the core balance current transformer 26, through which the mains cables to be protected are passed, with the piezo-element being in the form of a bending strip and being disposed differently in the configurations shown in the individual FIGS. 1-6.

In the embodiment shown in FIG. 2, a bending strip 32 runs parallel to the mounting plane 30, with an end 33 which can bend being located facing the area 29. The other end 34 is clamped in firmly, at the end opposite the area 29. The end 33 of the bending strip 32 acts on an approximately L-shaped lever, which is used as a coupling piece 35. A pivoting point 37 is provided at the one end of an arm 36, which runs at right angles to the mounting side 30, by which pivoting point 37 the coupling piece 35 is mounted in a fixed position in the service switching device 10. Another arm 38 is located closer to the end surfaces 14, and its free end acts on an arm 201 of the double-armed lever 20. A tab 39 is provided in the region of the rotating shaft 37, and projects into the bending path of the end 33 of the bending strip 32. When a fault current occurs, the bending strip 32 bends clockwise, and pivots counterclockwise the coupling piece 35 via the tab 39, as a result of which the coupling piece acts on the arm 201 of the double-armed lever 20. The latching point is unlatched via the slide 18.

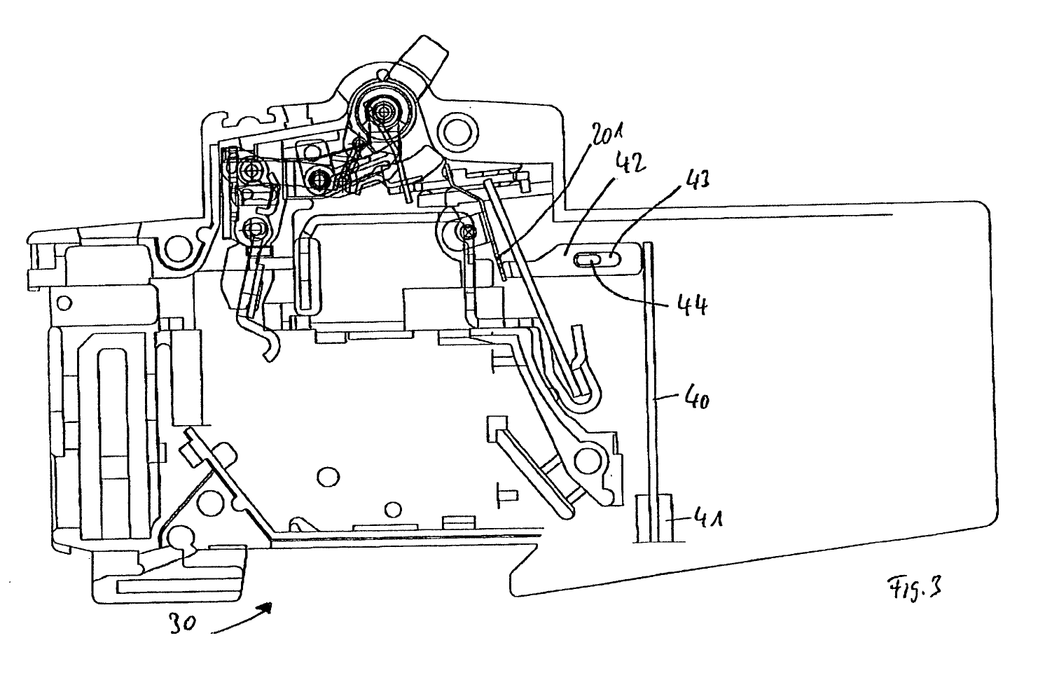

In the embodiment shown in FIG. 3, a bending strip 40 is provided which runs at right angles to the mounting side 30 and is clamped in a fixed position at 41, in the region of the mounting side 30. The bending strip 40 acts on a slide element 42, which is used as a coupling element 42 and which, in the present configuration, has an elongated hole 43, by which it is guided, such that it moves longitudinally, on a tab or strip 44. The coupling piece 42 runs parallel to the mounting side 30, and acts on the arm 201.

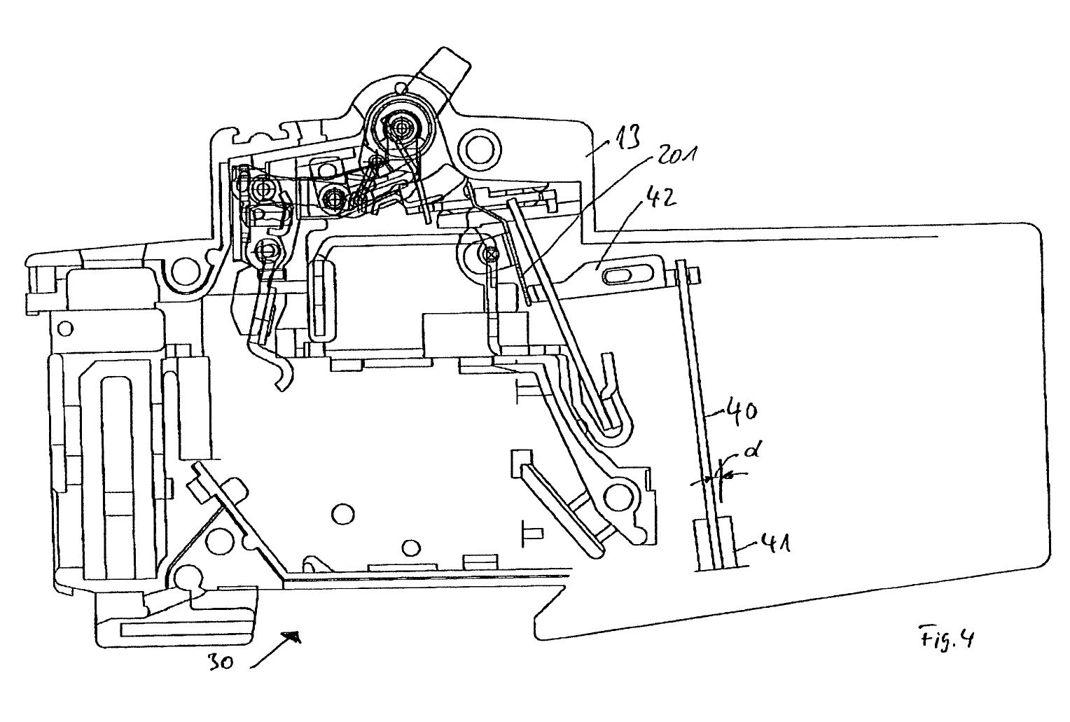

In the embodiment shown in FIG. 4, the bending strip 40 is disposed tilted or inclined through an angle alpha toward the switching chamber; the bending strip 40 forms an acute angle alpha with the mounting side or plane 30. The coupling piece 42 is accordingly also rotated through the same angle, with the angle between the coupling piece 42 and the bending strip 40 being approximately 90 degrees. Starting from the mounting point 41, the free end of the bending strip 40 is inclined toward the magnet armature or toward the web 13.

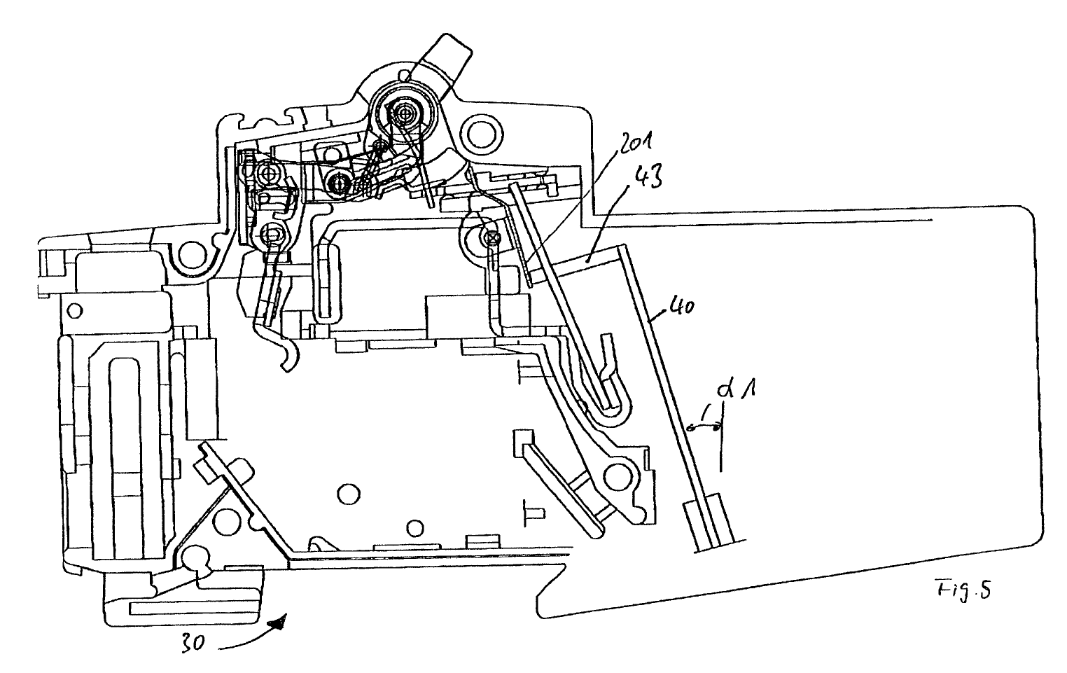

In the embodiment shown in FIG. 5, the angle alpha 1 between the line which runs at right angles to the mounting side 30 is greater than the angle alpha. A coupling piece 43 is mounted on the free end of the bending strip 40, with the coupling piece 43 running at right angles to the bending strip 40, and interacting with the arm 201.

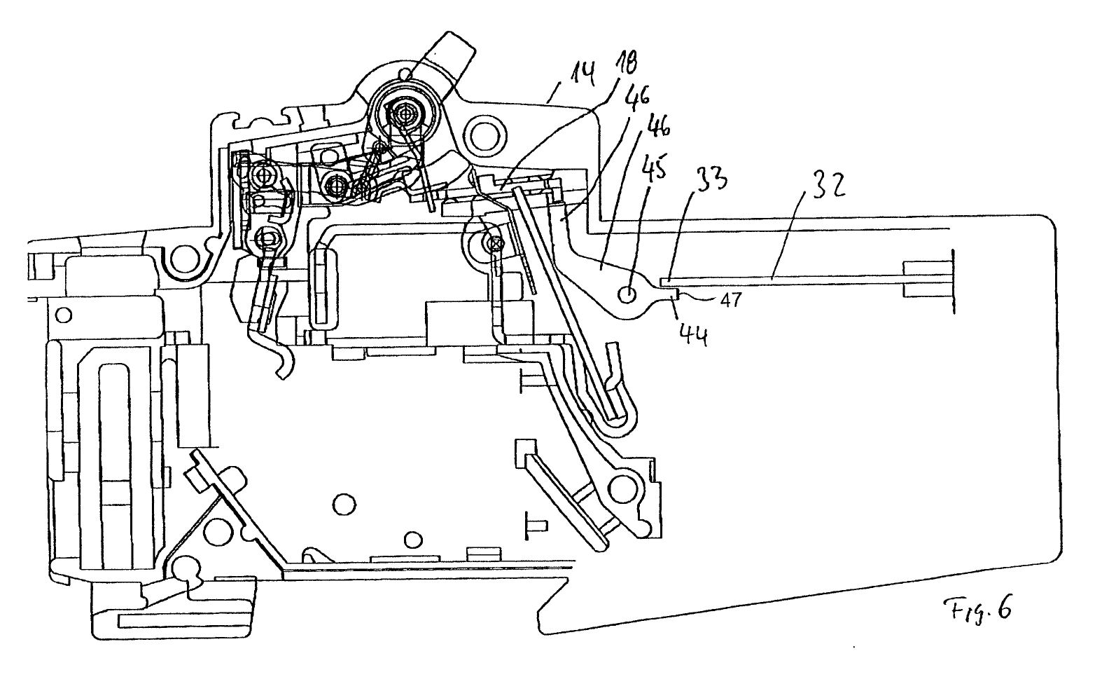

In the refinement shown in FIG. 6, the bending strip 32 is located closer to the end face 14. The free end 33 acts on a tab 44 of an L-shaped coupling piece 46 which is mounted at a rotation point 45 such that it can rotate. The coupling piece 46 is in this case in the form of a type of double lever, with the tab 44 forming an arm 47. The other arm runs approximately at right angles to the end face 14, to be precise facing the end face 14, where it interacts with the slide 18. When a fault current occurs, the bending strip 32 bends, as shown in FIG. 6, counterclockwise, and pivots the coupling piece 46 clockwise. The slide 18 is thus moved in order to unlatch the latching point.

The fault current detection device may be configured to be independent of the mains voltage or to be dependent on the mains voltage. The piezo-actuator in a version which is dependent on the mains voltage allows advantageous operation down to a mains voltage of 50 V.

We claim:

1. A service switching device, comprising:
a thermal release;
an electromagnetic release;
a switching mechanism with a latching point;
a contact point with a moving contact piece and a stationary contact piece, when an over-current condition occurs, said thermal release unlatches said latching point so that said contact point is opened permanently and, when a short-circuit current condition occurs, said electromagnetic release moves said moving contact piece to an open position;
a housing;
an actuator in a form of a piezoelectric bending strip disposed in said housing, said actuator acts on said latching point in order to open said contact point permanently; and
a fault current detection device outputting an output signal for driving said actuator when a fault current occurs.

2. The service switching device according to claim 1, wherein said housing has broad sides, a mounting side, and a widened region projecting in a direction of said broad sides and said mounting side, and said widened region holds said actuator together with said fault current detection device.

3. The service switching device according to claim 2, wherein said actuator runs substantially parallel to said mounting side.

4. The service switching device according to claim 2, wherein said actuator is disposed substantially at right angles to said mounting side, said actuator having an end facing said mounting side and a clamping-in point clamping said end.

5. The service switching device according to claim 4, wherein said actuator is inclined with respect to said mounting side at an angle which is not equal to 90 degrees.

6. The service switching device according to claim 1, wherein said actuator acts directly on said latching point.

7. The service switching device according to claim 2, further comprising:
a slide running substantially parallel to said mounting side, said thermal release and said actuator act on said slide;
an armature;
a double-armed lever acted on by said armature, said double-armed lever acts on said slide, and via said slide said latching point is unlatched.

8. The service switching device according to claim 2, further comprising a coupling piece, and said actuator acts on said latching point through said coupling piece.

9. The service switching device according to claim 8, wherein said coupling piece is an L-shaped lever having an arm with an arm end mounted such that said L-shaped lever can rotate and, in a region of a rotation axis, said L-shaped lever has a tab on which said actuator acts.

10. The service switching device according to claim 8, wherein said coupling piece is a slide element.

11. The service switching device according to claim 8, further comprising a double-armed lever and said coupling piece acts on said double-armed lever.

12. The service switching device according to claim 8, wherein said coupling piece is mounted on said actuator.
